(19) United States
(12) Patent Application Publication
(10) Pub. No.: US 2014/0304180 A1
(43) Pub. Date: Oct. 9, 2014

(54) METHOD, SYSTEM AND COMPUTER-READABLE STORAGE MEDIUM FOR DIVIDING A USER'S SOCIAL NETWORK RELATIONSHIP CIRCLE

(71) Applicant: TENCENT TECHNOLOGY (SHENZHEN) COMPANY LIMITED, Shenzhen (CN)

(72) Inventors: Peng He, Shenzhen (CN); Yuewen Liu, Shenzhen (CN); Yuhuang Li, Shenzhen (CN); Junming Mai, Shenzhen (CN); Chuan Chen, Shenzhen (CN); Weihua Chen, Shenzhen (CN)

(73) Assignee: TENCENT TECHNOLOGY (SHENZHEN) COMPANY LIMITED, Shenzhen (CN)

(21) Appl. No.: 14/245,477

(22) Filed: Apr. 4, 2014

Related U.S. Application Data
(63) Continuation of application No. PCT/CN2013/074034, filed on Apr. 10, 2013.

(30) Foreign Application Priority Data
May 15, 2012 (CN) 201210149996.3

(51) Int. Cl. G06Q 50/00; G06Q 10/00

(52) U.S. Cl. CPC G06Q 50/01; G06Q 10/00
USPC 705/319

(57) ABSTRACT

A method and system for dividing a user's social network relationship circle is disclosed. The method includes generating relevancy attribute information between friends of a first user according to social information of the first user's friends. A level of closeness between the friends according to the relevancy attribute information is acquired. The friends with the level of closeness greater than a first threshold are associated with a same relationship circle of the first user. The above method divides the friends of the user who have a high degree of closeness to the same relationship circle automatically. Thus, the efficiency of managing the social network for users is improved.

### CROSS-REFERENCE TO RELATED APPLICATIONS

The present application is a continuation application of an International Application No. PCT/CN2013/074034, filed on Apr. 10, 2013, entitled “METHOD, SYSTEM AND COMPUTER-READABLE STORAGE MEDIUM FOR DIVIDING A USER'S SOCIAL NETWORK RELATIONSHIP CIRCLE,” by Peng HE, Yuewen LIU, Yuhuang LI, Junming MAI, Chuan CHEN and Weihua CHEN, which claims the priority from the Chinese patent application No. CN201210149996.3, filed on May 15, 2012, entitled “METHOD, SYSTEM AND COMPUTER-READABLE STORAGE MEDIUM FOR DIVIDING A USER′S SOCIAL NETWORK RELATIONSHIP CIRCLE” by Peng HE, Yuewen LIU, Yuhuang LI, Junming MAI, Chuan CHEN and Weihua CHEN, the disclosures of which are incorporated in their entireties herein by reference.

### FIELD OF THE INVENTION

The present disclosure relates to the field of network technology, and more particularly, to a method, system and computer-readable storage medium for dividing a user's social network relationship circle.

### BACKGROUND OF THE INVENTION

Social network service (SNS) specifically refers to an Internet applicable service designed to help people build social network relationships. It also refers to an existing all-pervading information carrier, such as Short Messaging Service (SMS).

With the development of the social network service, the social network service has become one of the most important channels for people to access information, entertain and communicate with others. The social relationship built by the social network service is called social network relationship, which includes friendship, group membership, community relationship, listening relationship, following relationship and communication relationship. Wherein, if user A is a friend of user B or user B is a friend of user A, there is a unidirectional friendship between user A and user B, and if user A and user B are friends with each other, there is a bidirectional friendship between user A and user B; there is a group membership between users who belong to the same social group or discussion group, there is a community relationship between users who belong to the same community; if user A listens to a message of user B, user B listens to a message of user A or user A and user B listen to each other, there is a listening relationship between user A and user B; and similarly, if user A follows user B, user B follows user A or user A and user B follow each other, there is a following relationship between user A and user B. All of the relationships generated in the social network by a user with others are called a user's social network relationships.

In the social network service, there is a direct or indirect social network relationship between users, and the direct or indirect social network relationship between users forms a certain relationship chain or relationship circle. The social network relationship circle is generally managed by dividing groups by the user. The user creates groups, names the groups and sets the group the friend belongs to in the friend attributes to divide friends into designated groups.

Traditionally, the social network relationship circle is divided manually by users. It is low in efficiency.

### SUMMARY OF THE INVENTION

In view of the above, an object of the present disclosure is to provide a method for improving the efficiency of dividing a user's social network relationship circle.

According to one aspect of the disclosure, a method for dividing a user's social network relationship circle includes:

generating relevancy attribute information between friends of a first user according to social information of the first user's friends;

acquiring a level of closeness between the friends according to the relevancy attribute information; and

associating the friends with the level of closeness greater than a first threshold with a same relationship circle of the first user.

It is a further object of the present disclosure to provide a system for improving the efficiency of dividing a user's social network relationship circle.

According to an additional aspect of the disclosure, a system for dividing a user's social network relationship circle includes:

a relevancy attribute information generation module configured to generate relevancy attribute information between friends of a first user according to social information of the first user's friends;

a level of closeness calculation module configured to acquire a level of closeness between the friends according to the relevancy attribute information; and

a relationship circle division module configured to associate the friends with the level of closeness greater than a first threshold with a same relationship circle of the first user.

It is still a further object of the present disclosure to provide a computer-readable storage medium.

According to a further aspect of the disclosure, a non-transitory computer-readable storage medium includes a computer executable program which executes a method for dividing a user's social network relationship circle, wherein the method includes:

generating relevancy attribute information between friends of a first user according to social information of the first user's friends;

acquiring a level of closeness between the friends according to the relevancy attribute information; and

associating the friends with the level of closeness greater than a first threshold with a same relationship circle of the first user.

The above method, system, and executable program in the computer-readable storage medium for dividing a user's social network relationship circle includes generating relevancy attribute information between friends of a first user according to social information of the first user's friends, acquiring a level of closeness between the friends according to the relevancy attribute information, and dividing the friends of the user who have close relevancy attribute information to a same relationship circle, without a manual management of dividing friends by the user. In this regard, the efficiency of managing the social network relationship for users is improved. In addition, members having a high similarity have more common topics, and dividing the members having high similarity in to the same relationship circle can help the user to raise a common topic that members in the relationship circle all have interest in and promote member interaction in the circle. Thus, the accuracy of the relationship circle is improved and dividing a relationship circle is more efficient.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 is a flow diagram illustrating a method for dividing a user's social network relationship circle according to one embodiment of the present disclosure.

FIG. 2 is a flow diagram illustrating a method for expanding a user's social network relationship circle according to one embodiment of the present disclosure.

FIG. 3 is a flow diagram illustrating a method for filtering a user's social network relationship circle according to one embodiment of the present disclosure.

FIG. 4 is a flow diagram illustrating a step of acquiring a user account set according to one embodiment of the present disclosure.

FIG. 5 is a schematic diagram illustrating a system for dividing a user's social network relationship circle according to one embodiment of the present disclosure.

FIG. 6 is a schematic diagram illustrating a system for dividing a user's social network relationship circle according to another embodiment of the present disclosure.

FIG. 7 is a schematic diagram illustrating a system for dividing a user's social network relationship circle according to a further embodiment of the present disclosure.

### DETAILED DESCRIPTION OF THE INVENTION

In the following description of the various embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

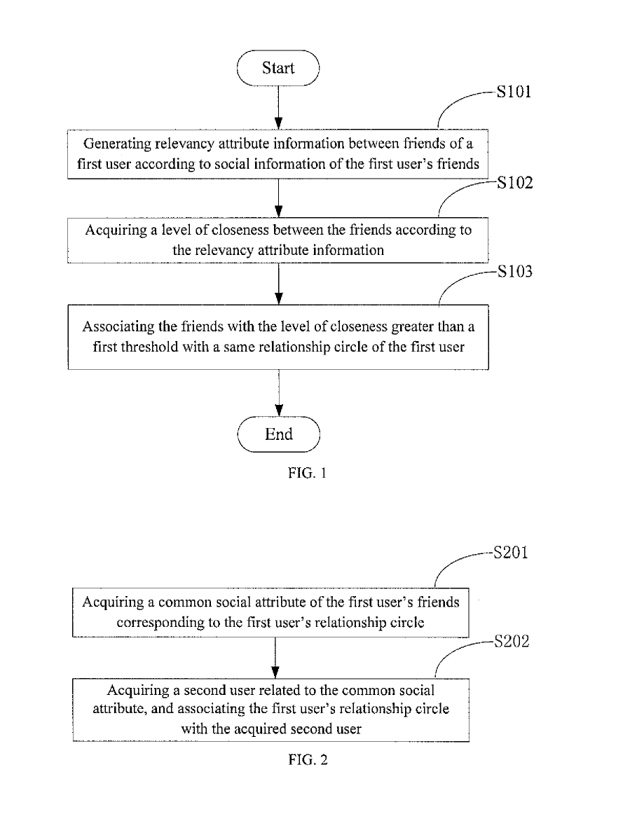

As shown in FIG. 1, a method for dividing a user's social network relationship circle according to one embodiment of the present disclosure includes:

Step S101, generating relevancy attribute information between friends of a first user according to social information of the first user's friends.

In one embodiment of the present disclosure, the social information of the first user's friends includes one or more selected from the group comprising social network relationships of the first user's friends, interaction records between the first user's friends and label group information of the first user's friends.

In one embodiment of the present disclosure, the interaction records include instant messaging records, mail exchange records, records of accessing, forwarding or commenting each other's published information, and records of accessing each other's social space. The label group information includes comment information or a label which a user assigns to other users, and group information for other users.

Specifically, the relevancy attribute information includes one or more selected from the group comprising whether there is a friendship, the frequency of interaction and the score of similarity of the label group information.

Specifically, in one embodiment of the present disclosure, whether there is a friendship between the friends of the first user can be determined by the social network relationship of the first user's friends. Additionally, the frequency of interaction between friends can be counted by interaction records of the first user's friends. Further, the score of similarity of the label group information between friends can be calculated by the label group information between the first user's friends. Specifically, the same information included in the label group information can be matched between friends, and the score of similarity between friends can be added up following the same information. For example, when the comment information set in the friends are the same, such as both are “close friend,” then the score corresponding to the comment information can be added to the score of similarity between the friends.

Step S102, acquiring a level of closeness between the first user's friends according to the relevancy attribute information between the first user's friends.

Specifically, acquiring a level of closeness between the first user's friends according to the relevancy attribute information of the first user's friends includes whether there is a friendship, and/or the frequency of interaction, and/or the score of similarity of the label group information.

In one embodiment of the present disclosure, if there is a friendship between the first user's friends, the attribute information can be set to 1. Otherwise, the attribute information can be set to 0. In one embodiment of the present disclosure, the weight coefficient of the attribute that includes whether there is a friendship, and/or the frequency of interaction, and/or the score of similarity of the label group information, included in the relevancy attribute information can be preset. Further, the weighted sum of the attribute included in the relevancy attribute information can be calculated based on the weight coefficient preset and an attribute value in the relevancy attribute information corresponding to the weight coefficient. In this regard, the level of closeness between the first user's friends can be set as the weighted sum.

Step S103, associating the friends with the level of closeness greater than a first threshold with a same relationship circle of the first user.

In one embodiment of the present disclosure, a relationship circle list or relationship circle array can be created, and the user's friends with the level of closeness greater than the threshold can be stored in a same list or array.

In another embodiment of the present disclosure, a table of correspondence between the first user's friends and the first user's relationship circle can be created, and the first user's friends and the first user's relationship circle corresponding to the first user's friends can be relatively stored in the table of correspondence.

Users corresponding to the first user's relationship circle, including the first user's friends, can be considered members in the first user's relationship circle or members in the relationship circle in the following for simplicity.

Specifically, the level of closeness of the relevancy attribute information between every member in a same relationship circle and other members in the relationship circle are greater than the threshold. For example, if the level of closeness of the relevancy attribute information between friend A and friend B, friend A and friend C, and friend B and friend C is greater than the threshold, friend A, friend B, and friend C correspond to the same relationship circle of the first user.

In another embodiment of the present disclosure, the name of the relationship circle can be set based on the label group information between members in the relationship circle. For example, if the comment information of every member in a relationship circle for other members in the relationship circle is “schoolmate,” or other members in a relationship circle are in a “schoolmate” group for every member in the relationship circle, the name of the relationship circle can be set as “schoolmate.”

The above method for dividing a user's social network relationship circle generates relevancy attribute information between the user's friends according to social information between the user's friends, acquires a level of closeness between the friends according to the relevancy attribute information, and divides the user's friends who have close relevancy attribute information to a same relationship circle without a manual management of dividing friends by the user. Thus, the efficiency of managing a social network relationship for users is improved. In addition, members having a high similarity have more common topics, and dividing the members having high similarity in to a same relationship circle can help the user to raise a common topic that members in the relationship circle all have interest in and promote member interaction in the circle. Thus, the accuracy of the relationship circle is improved and dividing a relationship circle is more efficient.

As show in FIG. 2, the above method for dividing a user's social network relationship circle according to one embodiment of the present disclosure further includes a step of expanding a user's social network relationship circle which includes:

Step S201, acquiring a common social attribute of the first user's friends corresponding to the first user's relationship circle.

In one embodiment of the present disclosure, the common social attribute of members in the relationship circle can be a common social attribute of partial members. Preferably, the number of the partial members exceeds a preset threshold. For example, a common social attribute of members accounting for over 80% of members in the relationship circle can be acquired. If one social attribute is a social attribute of members accounting for over 80% of members in the relationship circle, the social attribute can be classified as a common social attribute of members in the relationship circle.

In one embodiment of the present disclosure, a common social attribute includes a common friend, a common interaction object, a common social group and a common network community.

Specifically, a common friend, a common social group or a common network community of members in the relationship circle can be extracted according to the social network relationship of members in the relationship circle. In one embodiment of the present disclosure, a common interaction object of members in the relationship circle that has interactions with members in the relationship circle can be extracted according to the operating records of members in the relationship circle.

Step S202, acquiring a second user related to the common social attribute and associating the first user's relationship circle with the acquired second user.

Specifically, in one embodiment of the present disclosure, the common friend, and/or the common interaction object, and/or other members belonging to the common social group, and/or other members belonging to the common network community of the first user's friends corresponding to the first user's relationship circle can be acquired. Then, the relationship between the first user's relationship circle and the above acquired object can be set up.

Other members in the common social group that the first user's friends corresponding to the first user's relationship circle belong to refer to other members except the above friends (namely the first user's friends corresponding to the first user's relationship circle) in the common social group that the above friends belong to. Other members in the common network community that the first user's friends corresponding to the first user's relationship circle belong to refers to other members except the above friends in the common network community that the above friends belong to.

The above method acquires a second user having the common social attribute with the members in the first user's relationship circle. For example, a common friend, and/or a common interaction object, and/or other members belonging to a common social group, and/or other members belonging to a common network community of members in the relationship circle associate the first user's relationship circle with the acquired second user. In this regard, the acquired second user is probably an object that the first user expects to communicate with. The above method expands the user's relationship circle automatically according to the way the user expects, without the user having to manually expand the user's relationship circle. Thus, the efficiency of the management of the social network relationship for the user is improved.

In one embodiment of the present disclosure, the above method for dividing a user's social network relationship circle further includes a step of filtering a user's social network relationship circle which includes:

deleting the user corresponding to the first user's relationship circle when the average level of closeness of the user with other users of the first user's relationship circle is lower than a second threshold. Namely, if a user has an average level of closeness with other users of the first user's relationship circle that is lower than the second threshold, the user can be deleted.

Specifically, the level of closeness of members in the first user's relationship circle can be calculated by the relevancy attribute information between members in the relationship circle. The process of calculating the level of closeness can be the same as step S102 discussed above. Further, the average level of closeness between a member in the relationship circle and other members in the relationship circle can be calculated by the level of closeness between members in the relationship circle.

For example, a relationship circle includes user A, user B, and user C. The average level of closeness between user A and other members in the relationship circle is an average of the level of closeness between user A and user B and the level of closeness between user A and user C.

As shown in FIG. 3, a method for dividing a user's social network relationship circle according to another embodiment of the present disclosure further includes a step of filtering a user's social network relationship circle which includes:

Step S301, marking a user from the first user's relationship circle as a key member when the average level of closeness is greater than a third threshold corresponding to the closeness of other users of the first user's relationship circle. Namely, if a user has an average level of closeness that is higher than the third threshold corresponding to the closeness of other users in the first user's relationship circle, the user is marked as a key member.

Step S302, deleting the user corresponding to the first user's relationship circle when the average level of closeness of the key member to the fourth user is lower than a fourth threshold.

In the embodiment, a member is an active member in the relationship circle when a level of closeness corresponding to other members in the relationship circle with the same relevancy attribute information is greater than a preset threshold. The active member is marked as a key member to determine the core of the relationship circle. Further, a member that has an average level of closeness with the key member lower than the preset threshold is deleted. Low closeness means unfamiliar relationship, and deleting the member who is unfamiliar with the key member in the relationship circle can increase the cohesion of members in the relationship circle. In this regard, the method does not need a user to organize and maintain the user's relationship circle manually. Thus, the efficiency of the management of the social network relationship for the user is improved.

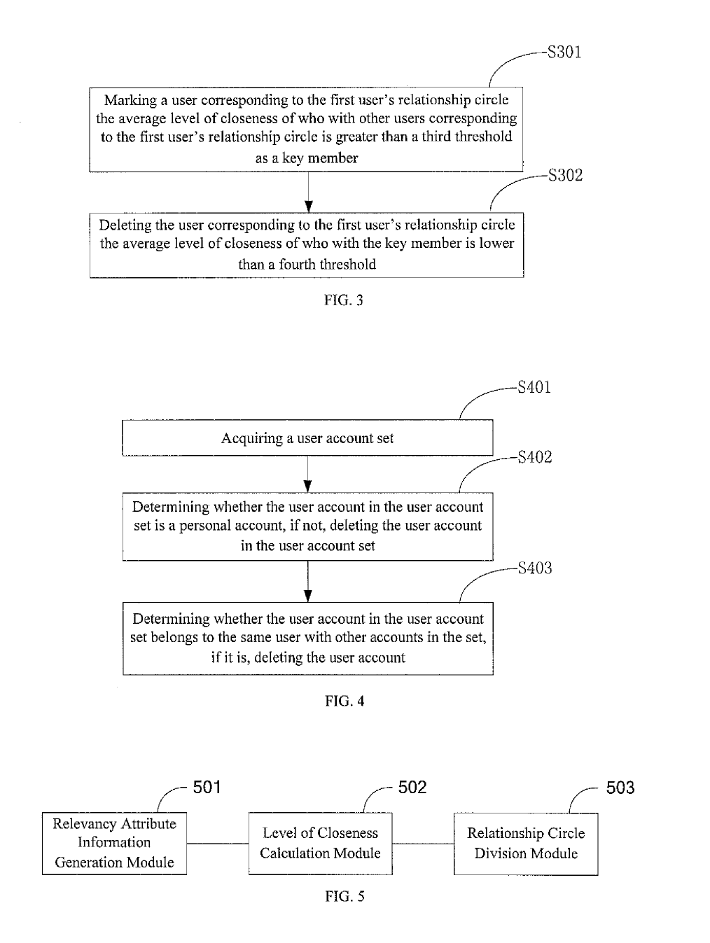

As shown in FIG. 4, before step S101, the method for dividing a user's social network relationship circle according to one embodiment of the present disclosure further includes acquiring a user account set which includes:

Step S401, acquiring a user account set.

Specifically, in one embodiment of the present disclosure, a user account of the user can be acquired from a social network user database, and the acquired user account can be grouped into a user account set.

Step S402, determining whether the user account in the user account set is a personal account, and if not, deleting the user account in the user account set.

A user account can be a personal account, a business account, or a group account, etc.

In one embodiment of the present disclosure, whether the user account is a personal account can be determined by the number of friends of the user account. The number of friends includes the number of users who have a unidirectional friendship with the user account and the number of users who have a bidirectional friendship with the user account. If the number of friends is higher than a preset threshold, the account can be determined to an impersonal account, because the number of friends of an impersonal account, for example, a business account or a group account, is generally larger.

In another embodiment of the present disclosure, a relevant characteristic of an impersonal account can be extracted by a traditional classification method, and a user account matching with the relevant characteristic can be filtered.

An impersonal account, such as a business account or a group account, is generally not a social network relationship that a personal user expects to extend because the social network relationship of an impersonal account is wider and has frequent interactive operation with larger users. If the impersonal account is not deleted, the impersonal account is likely to become a key member in the user's relationship circle. Therefore, filtering an impersonal account can remove the social network relationship that a personal user does not expect to extend, which makes the user's relationship circle extend in the direction that the user expects. Thus, the above method can improve the efficiency of the management of the social network relationship for the user.

Step S403, determining whether the user account in the user account set belongs to the same user with other accounts in the set, and if it does, deleting the user account.

In one embodiment of the present disclosure, whether the user account belongs to the same user can be determined by basic information of the user account and login time information and IP address information of the user account. In one embodiment of the present disclosure, if the basic information (e.g. name, age or label) of the user accounts are the same, most of the login times of the user accounts are close (e.g. the time interval is no more than one minute), or IP addresses of the user accounts in most of the online time are the same, the user accounts can be determined to belong to the same user.

When different user accounts of the same user are common friends of the user's friends, the user's different user accounts are possible to form the user's relationship circle. For example, a user has two user accounts A1 and A2. If A1 and A2 both are friends of B and C, when the relationship circle of A1 is extended, then it is possible for A2 to be a member of the relationship circle of A1 since A2 is a common friend of B and C. Therefore, deleting repeated accounts of the same user can avoid repetitive management of the social network relationship.

The first user, first user's friends and the second user in the above method for dividing a user's social network relationship circle are the users corresponding to the user accounts in the user account set that the impersonal account and the personal repeated account are filtered.

In the embodiment, the impersonal account and the personal repeated account are filtered, so the user's relationship circle can extend in the direction the user expects, and the repetitive management of the social network relationship due to repeated account can be avoided.

In one embodiment of the present disclosure, before step S101, the above method for dividing a user's social network relationship circle further includes acquiring the friendships between the users corresponding to the user account set, and complementing a unidirectional friendship in the friendships to a bidirectional friendship.

The first user's friends in the above method for dividing a user's social network relationship circle are the acquired friends of the first user according to the complemented friendship.

The user corresponding to the user account in the user account set is called the user corresponding to the user account set for short. Specifically, a user in the user corresponding to the above user account set is a friend of another user while the another user is not a friend of the user, and the another user is set as a friend of the user.

The unidirectional friendship is a closer social network relationship in the social network. Thus, dividing a user's social network relationship circle after complementing the unidirectional friendship to the bidirectional friendship can effectively increase original members in the user's relationship circle, so as to manage the social network relationship more effectively.

As shown in FIG. 5, in one embodiment of the present disclosure, a system for dividing a user's social network relationship circle includes a relevancy attribute information generation module 501, a level of closeness calculation module 502, and a relationship circle division module.

The relevancy attribute information generation module 501 is configured to generate relevancy attribute information between friends of a first user according to social information of the first user's friends.

In one embodiment of the present disclosure, the social information of the first user's friends includes one or more selected from the group consisting of: social network relationships of the first user's friends, interaction records between the first user's friends and label group information of the first user's friends.

In one embodiment of the present disclosure, the interaction records include instant messaging records, mail exchange records, records of accessing, forwarding or commenting each other's published information and records of accessing each other's social space. The label group information includes comment information or a label which a user assigns to other users, and group information for other users.

Specifically, the relevancy attribute information includes one or more selected from the group comprising whether there is a friendship, the frequency of interaction and the score of similarity of the label group information.

Specifically, in one embodiment of the present disclosure, the relevancy attribute information generation module 501 is configured to determine whether there is a friendship between the friends of the first user according to the social network relationship of the first user's friends. Additionally, the frequency of interaction between friends can be counted by interaction records of the first user's friends. Further, the score of similarity of the label group information between friends can be calculated by the label group information between the first user's friends. Specifically, the same information included in the label group information can be matched between friends, and the score of similarity between friends can be added up following the same information. For example, when the comment information set in the friends are the same, such as both are “close friend,” then the score corresponding to the comment information can be added to the score of similarity between the friends.

The level of closeness calculation module 502 is configured to acquire a level of closeness between the friends according to the relevancy attribute information.

Specifically, acquiring the level of closeness calculation module 502 is configured to acquire a level of closeness between the first user's friends according to the relevancy attribute information of the first user's friends includes whether there is a friendship, and/or the frequency of interaction, and/or the score of similarity of the label group information.

In one embodiment of the present disclosure, if there is a friendship between the first user's friends, the attribute information can be set to 1. Otherwise, the attribute information can be set to 0. In one embodiment of the present disclosure, the weight coefficient of the attribute that includes whether there is a friendship, and/or the frequency of interaction, and/or the score of similarity of the label group information, included in the relevancy attribute information can be preset. The level of closeness calculation module 502 can calculate the weighted sum of the attribute included in the relevancy attribute information according to the weight coefficient preset and an attribute value in the relevancy attribute information corresponding to the weight coefficient. In this regard, the level of closeness between the first user's friends can be set as the weighted sum.

The relationship circle division module 503 is configured to associate the friends with the level of closeness greater than a first threshold with a same relationship circle of the first user.

In one embodiment of the present disclosure, the relationship circle division module 503 is configured to create a relationship circle list or relationship circle array, and store the user's friends with the level of closeness greater than the threshold in a same list or array.

In another embodiment of the present disclosure, the relationship circle division module 503 is configured to create a table of correspondence between the first user's friends and the first user's relationship circle, and relatively store the first user's friends and the first user's relationship circle corresponding to the first user's friends in the table of correspondence.

Users corresponding to the first user's relationship circle, including the first user's friends, can be considered members in the first user's relationship circle or members in the relationship circle in the following for simplicity.

Specifically, the levels of closeness of the relevancy attribute information between every member in a same relationship circle and other members in the relationship circle are greater than the threshold. For example, if the levels of closeness of the relevancy attribute information between friend A and friend B, friend A and friend C, and friend B and friend C is greater than the threshold, friend A, friend B and friend C correspond to the same relationship circle of the first user.

In one embodiment of the present disclosure, the relationship circle division module 503 is configured to set the name of the relationship circle based on the label group information between members in the relationship circle. For example, if the comment information of every member in a relationship circle for other members in the relationship circle is “schoolmate,” or other members in a relationship circle are in a “schoolmate” group for every member in the relationship circle, the name of the relationship circle can be set as “schoolmate.”

The above system for dividing a user's social network relationship circle generates relevancy attribute information between the user's friends according to social information between the user's friends, acquires a level of closeness between the friends according to the relevancy attribute information, and divides the user's friends who have close relevancy attribute information to a same relationship circle without a manual management of dividing friends by the user. Thus, the efficiency of managing a social network relationship for users is improved. In addition, members having a high similarity have more common topics, and dividing the members having high similarity in to the same relationship circle can help the user to raise a common topic that members in the relationship circle all have interest in and promote member interaction in the circle. Therefore, the accuracy of the relationship circle is improved and dividing a relationship circle is more efficient.

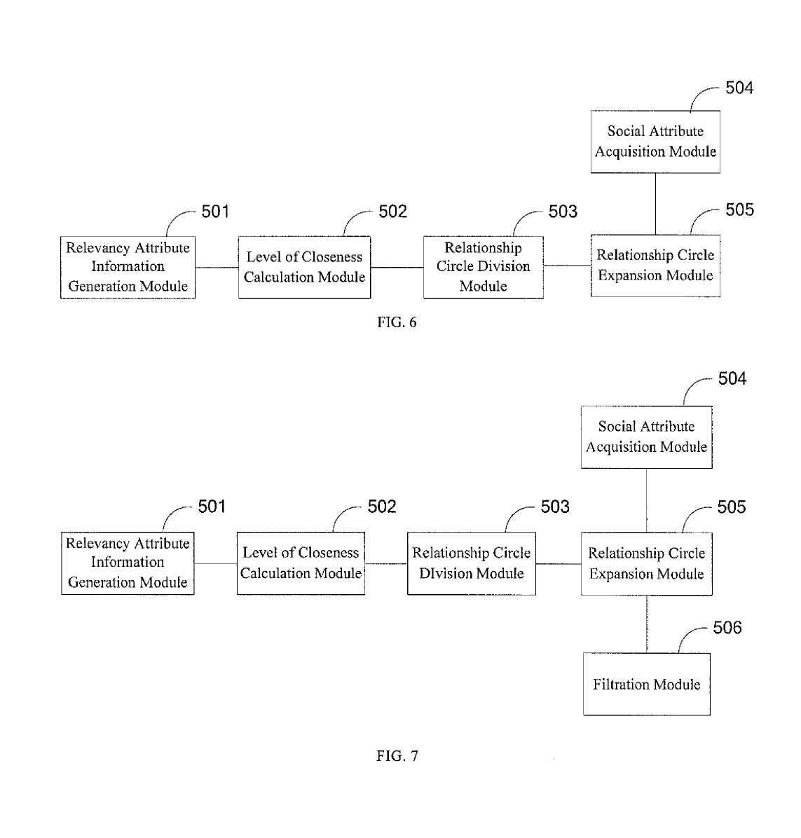

As show in FIG. 6, a system for dividing a user's social network relationship circle according to one embodiment of the present disclosure includes a social attribute acquisition module 504 and a relationship circle expansion module 505.

The social attribute acquisition module 504 is configured to acquire a common social attribute of the first user's friends corresponding to the first user's relationship circle.

In one embodiment of the present disclosure, the common social attribute of members in the relationship circle can be a common social attribute of partial members. Preferably, the number of the partial members exceeds a preset threshold. For example, a common social attribute of members accounting for over 80% of members in the relationship circle can be acquired. If one social attribute is a social attribute of members accounting for over 80% of members in the relationship circle, the social attribute can be classified as a common social attribute of members in the relationship circle.

In one embodiment of the present disclosure, a common social attribute includes a common friend, a common interaction object, a common social group and a common network community.

Specifically, a common friend, a common social group or a common network community of members in the relationship circle can be extracted according to the social network relationship of members in the relationship circle. In one embodiment of the present disclosure, a common interaction object of members in the relationship circle that has interactions with members in the relationship circle can be extracted according to the operating records of members in the relationship circle.

The relationship circle expansion module 505 is configured to acquire a second user related to the common social attribute, and associate the first user's relationship circle with the acquired second user.

Specifically, in one embodiment of the present disclosure, the common friend, and/or the common interaction object, and/or other members belonging to the common social group, and/or other members belonging to the common network community of the first user's friends corresponding to the first user's relationship circle can be acquired. Then, a relationship between the first user's relationship circle and the above acquired object can be set up.

Other members in the common social group that the first user's friends corresponding to the first user's relationship circle belong to refer to other members except the above friends (namely the first user's friends corresponding to the first user's relationship circle) in the common social group that the above friends belong to. Other members in the common network community that the first user's friends corresponding to the first user's relationship circle belong to refers to other members except the above friends in the common network community that the above friends belong to.

The above system acquires a second user having the common social attribute with the members in the first user's relationship circle. For example, a common friend, and/or a common interaction object, and/or other members belonging to a common social group, and/or other members belonging to a common network community of members in the relationship circle associate the first user's relationship circle with the acquired second user. In this regard, the acquired second user is probably an object that the first user expects to communicate with. The above system expands the user's relationship circle automatically according to the way the user expects, without the user having to manually expand the user's relationship circle. Thus, the efficiency of the management of the social network relationship for the user is improved.

As shown in FIG. 7, a system for dividing a user's social network relationship circle according to one embodiment of the present disclosure further includes a filtration module 506 which is configured to delete the user corresponding to the first user's relationship circle when the average level of closeness of the user with other users of the first user's relationship circle is lower than a second threshold. Namely, if a user has an average level of closeness with other users of the first user's relationship circle that is lower than the second threshold, the filtration module 506 deletes the user.

Specifically, the filtration module 506 is configured to calculate the level of closeness of members in the first user's relationship circle according to the relevancy attribute information between members in the relationship circle. Further, it is configured to calculate the average level of closeness between a member in the relationship circle and other members in the relationship circle according to the level of closeness between members in the relationship circle.

For example, a relationship circle includes user A, user B and user C. The average level of closeness between user A and other members in the relationship circle is an average of the level of closeness between user A and user B and the level of closeness between user A and user C.

In another embodiment of the present disclosure, the filtration module 506 is configured to mark a user from the first user's relationship circle as a key member when the average level of closeness is greater than a third threshold corresponding to the closeness of other users of the first user's relationship circle. The filtration module 506 is also configured to delete the user from the first user's relationship circle when the average level of closeness of the key member to the fourth user is lower than a fourth threshold. Namely, if a user has an average level of closeness that is higher than the third threshold corresponding to the closeness of other users in the first user's relationship circle, the filtration module 506 marks the user as a key member and deletes the user that has an average level of closeness with the key member that is lower than the fourth threshold.

In the embodiment, a member is an active member in the relationship circle when a level of closeness corresponding to other members in the relationship circle with the same relevancy attribute information is greater than a preset threshold. The active member is marked as a key member to determine the core of the relationship circle. Further, a member that has an average level of closeness with the key member lower than the preset threshold is deleted. Low closeness means unfamiliar relationship, and deleting the member who is unfamiliar with the key member in the relationship circle can increase the cohesion of members in the relationship circle. In this regard, the system does not need a user to organize and maintain the user's relationship circle manually. Thus, the efficiency of the management of the social network relationship for the user is improved.

In one embodiment of the present disclosure, the above system for dividing a user's social network relationship circle further includes a user acquisition module (not shown) which is configured to acquire a user account set, determine whether the user account in the user account set is a personal account, if not, delete the user account in the user account set, and determine whether the user account in the user account set belongs to a same user with other accounts in the set, and if it is, delete the user account.

A user account can be a personal account, a business account, or a group account, etc.

In one embodiment of the present disclosure, the user acquisition module is configured to determine whether the user account is a personal account according to the number of friends of the user account. The number of friends includes the number of users who have a unidirectional friendship with the user account and the number of users who have a bidirectional friendship with the user account. If the number of friends is higher than a preset threshold, the account can be determined to an impersonal account, because the number of friends of an impersonal account, for example, a business account or a group account, is generally larger.

In another embodiment of the present disclosure, the user acquisition module is configured to extract a relevant characteristic of an impersonal account by a traditional classification method, and filter a user account matching with the relevant characteristic.

An impersonal account, such as a business account or a group account, is generally not a social network relationship that a personal user expects to extend because the social network relationship of an impersonal account is wider and has frequent interactive operation with larger users. If the impersonal account is not deleted, the impersonal account is likely to become a key member in the user's relationship circle. Therefore, filtering an impersonal account can remove the social network relationship that a personal user does not expect to extend, which makes the user's relationship circle extend in the direction that the user expects. Thus, the above method can improve the efficiency of the management of the social network relationship for the user.

Further, in one embodiment of the present disclosure, the user acquisition module is configured to determine whether the user account belongs to the same user according to basic information of the user account and login time information and IP address information of the user account. In one embodiment of the present disclosure, if the basic information (e.g. name, age or label) of the user accounts are the same, most of the login times of the user accounts are close (e.g. the time interval is no more than one minute), or IP addresses of the user accounts in most of the online time are the same, the user acquisition module can determine the user accounts belongs to a same user, and delete the repeated accounts belong to the same user in the user account information such that only one user account is saved for one user.

When different user accounts of the same user are common friends of the user's friends, the user's different user accounts are possible to form the user's relationship circle. For example, a user has two user accounts A1 and A2. If A1 and A2 both are friends of B and C, when the relationship circle of A1 is extended, the it is possible for A2 to be a member of the relationship circle of A1 since A2 is a common friend of B and C. Therefore, deleting repeated accounts of the same user can avoid repetitive management of the social network relationship.

The first user, first user's friends and the second user in the above system for dividing a user's social network relationship circle are the users corresponding to the user accounts in the user account set that the impersonal account and the personal repeated account are filtered.

In the embodiment, the impersonal account and the personal repeated account are filtered, so the user's relationship circle can extend in the direction the user expects, and the repetitive management of the social network relationship due to repeated account can be avoided.

In one embodiment of the present disclosure, the above system for dividing a user's social network relationship circle further includes a relationship complement module (not shown) which is configured to acquire the friendships between the users corresponding to the user account set, and complement a unidirectional friendship in the friendships to a bidirectional friendship.

The first user's friends in the above method for dividing a user's social network relationship circle are the acquired friends of the first user according to the complemented friendship.

The user corresponding to the user account in the user account set is called the user corresponding to the user account set for short. Specifically, a user in the user corresponding to the above user account set is a friend of another user while the another user is not a friend of the user, and the another user is set as a friend of the user.

The unidirectional friendship is a closer social network relationship in the social network. Thus, dividing a user's social network relationship circle after complementing the unidirectional friendship to the bidirectional friendship can effectively increase original members in the user's relationship circle, so as to manage the social network relationship more effectively.

It will be appreciated for those skilled in the art that parts of or overall process in the above embodiments can be implemented by related hardware controlled by computer program, the computer program can be stored in a computer-readable storage medium, and when the computer program is executed, it can include the processes of the above embodiments of each method. Wherein, the computer-readable storage medium can be a disc, a compact disc, a Read-Only Memory or a Random Access Memory.

Although the invention herein has been described with reference to various embodiments, it is to be understood that the embodiments are merely illustrative of the principles and applications of the present invention. It is therefore to be understood that a number of variations and modifications may be made to the illustrative embodiments without departing from the inventive spirit and scope of the present disclosure. Accordingly, the scope of the present disclosure is defined by the appended claims rather than the foregoing description and the exemplary embodiments described therein.

1. A method for dividing a user's social network relationship circle, comprising:
generating relevancy attribute information between friends of a first user according to social information of the first user's friends;
acquiring a level of closeness between the friends according to the relevancy attribute information; and
associating the friends with the level of closeness greater than a first threshold with a same relationship circle of the first user.

2. The method of claim 1, wherein the social information of the first user's friends comprises one or more selected from the group consisting of: social network relationships of the first user's friends, interaction records between the first user's friends, and label group information of the first user's friends, and
wherein the relevancy attribute information comprises one or more selected from the group consisting of: whether there is a friendship, a frequency of interaction, and a score of similarity of the label group information.

3. The method of claim 1, further comprising:
acquiring a common social attribute of the friends corresponding to the first user's relationship circle; and
acquiring a second user related to the common social attribute, and
associating the first user's relationship circle with the second user.

4. The method of claim 3, wherein the common social attribute comprises a common friend, a common interaction object, a common social group and a common network community, and
the steps of acquiring a second user related to the common social attribute and associating the first user's relationship circle with the second user further comprises:
acquiring the common friend, and/or the common interaction object, and/or other members belonging to the common social group, and/or other members belonging to the common network community of the friends corresponding to the first user's relationship circle, and
setting up a relationship between the first user's relationship circle and the acquired object.

5. The method claim 3, further comprising:
deleting a user from the first user's relationship circle when the average level of closeness is lower than a second threshold corresponding to the closeness of other users of the first user's relationship circle.

6. The method claim 3, further comprising:
marking a third user from the first user's relationship circle as a key member when the average level of closeness is greater than a third threshold corresponding to the closeness of other users of the first user's relationship circle; and
deleting a fourth user from the first user's relationship circle when the average level of closeness of the key member to the fourth user is lower than a fourth threshold.

7. The method of claim 1, wherein before the step of generating the relevancy attribute information between friends of the first user according to social information of the first user's friends, the method further comprises:
acquiring a user account set;
determining whether a user account in the user account set is a personal account,
if the user account is not a personal account, deleting the user account from the user account set; and
determining whether the user account in the user account set belongs to the same user with other user accounts in the set,
if the user account belongs to the same user with other user accounts in the set, deleting the user account,
wherein the first user, first user's friends, and a second user are the users corresponding to the user accounts in the user account set.

8. The method of claim 7, wherein before the step of generating the relevancy attribute information between friends of the first user according to social information of the first user's friends, the method further comprises:
acquiring the friendships between the users corresponding to the user account set, and complementing a unidirectional friendship in the friendships to a bidirectional friendship,
wherein the first user's friends are the acquired friends of the first user according to the complemented friendship.

9. A system for dividing a user's social network relationship circle, comprising:
a relevancy attribute information generation module configured to generate relevancy attribute information between friends of a first user according to social information of the first user's friends;
a level of closeness calculation module configured to acquire a level of closeness between the friends according to the relevancy attribute information; and
a relationship circle division module configured to associate the friends with the level of closeness greater than a first threshold with a same relationship circle of the first user.

10. The system of claim 9, wherein the social information of the first user's friends comprises one or more selected from the group consisting of: social network relationships of the first user's friends, interaction records between the first user's friends, and label group information of the first user's friends, and
wherein the relevancy attribute information comprises one or more selected from the group consisting of: whether there is a friendship, a frequency of interaction, and score of similarity of the label group information.

11. The system of claim 9, further comprising:
a social attribute acquisition module configured to acquire a common social attribute of the friends corresponding to the first user's relationship circle; and
a relationship circle expansion module configured to acquire a second user related to the common social attribute and to associate the first user's relationship circle with the second user.

12. The system of claim 11, wherein the common social attribute comprises a common friend, a common interaction object, a common social group and a common network community, and
the relationship circle expansion module is configured to acquire the common friend, and/or the common interaction object, and/or other members belonging to the common social group, and/or other members belonging to the common network community of the friends corresponding to the first user's relationship circle and to set up a relationship between the first user's relationship circle and the above acquired object.

13. The system of claim 11, further comprising:
a filtration module configured to delete a user from the first user's relationship circle when the average level of closeness is lower than a second threshold corresponding to closeness of other users of the first user's relationship circle.

14. The system of claim 11, wherein the filtration module is further configured to mark a third user from the first user's relationship circle as a key member when the average level of closeness is greater than a third threshold corresponding to the closeness of other users of the first user's relationship circle and to delete a fourth user from the first user's relationship circle when the average level of closeness of the key member to the fourth user is lower than a fourth threshold.

15. The system of claim 9, further comprising:
a user acquisition module configured to acquire a user account set, to determine whether a user account in the user account set is a personal account, if the user account is not a personal account, to delete the user account from the user account set, and to determine whether the user account in the user account set belongs to a same user with other user accounts in the set, if is the user account belongs to the same user with other user accounts in the set, to delete the user account,
wherein the first user's friends and a second user are the users corresponding to the user accounts in the user account set.

16. The system of claim 15, further comprising:
a relationship complement module configured to acquire the friendships between the users corresponding to the user account set and to complement a unidirectional friendship in the friendships to a bidirectional friendship,
wherein the first user's friends are the acquired friends of the first user according to the complemented friendship.

17. A non-transitory computer-readable storage medium storing computer executable instructions, that when executed by a processor, perform the steps of:
generating relevancy attribute information between friends of a first user according to social information of the first user's friends;
acquiring a level of closeness between the friends according to the relevancy attribute information; and
associating the friends with the level of closeness greater than a first threshold with a same relationship circle of the first user.

18. The non-transitory computer-readable storage medium of claim 17, wherein the social information of the first user's friends comprises one or more selected from the group consisting of: social network relationships of the first user's friends, interaction records between the first user's friends, and label group information of the first user's friends, and
wherein the relevancy attribute information comprises one or more selected from the group consisting of: whether there is a friendship, the frequency of interaction, and the score of similarity of the label group information.

19. The non-transitory computer-readable storage medium of claim 17, wherein the instructions further comprises:
acquiring a common social attribute of the friends corresponding to the first user's relationship circle;
acquiring a second user related to the common social attribute; and
associating the first user's relationship circle with the second user.

20. The non-transitory computer-readable storage medium of claim 19, wherein the common social attribute comprises a common friend, a common interaction object, a common social group and a common network community, and
the steps of acquiring a second user related to the common social attribute and associating the first user's relationship circle with the second user further comprises:
acquiring the common friend, and/or the common interaction object, and/or other members to the common social group, and/or other members to the common network community of the friends corresponding to the first user's relationship circle, and
setting up a relationship between the first user's relationship circle and the acquired object.

21. The non-transitory computer-readable storage medium of claim 19, wherein the instructions further comprises:
deleting a user from the first user's relationship circle when the average level of closeness is lower than a second threshold corresponding to the closeness of other users of the first user's relationship circle.

22. The non-transitory computer-readable storage medium of claim 19, wherein the instructions further comprises:
marking a third user from the first user's relationship circle as a key member when the average level of closeness is greater than a third threshold corresponding to the closeness of other users of the first user's relationship circle; and
deleting a fourth user from the first user's relationship circle when the average level of closeness of the key member to the fourth user is lower than a fourth threshold.

23. The non-transitory computer-readable storage medium of claim 17, wherein before the step of generating the relevancy attribute information between friends of the first user according to social information of the first user's friends, the method further comprises:
acquiring a user account set;
determining whether a user account in the user account set is a personal account,
if the user account is not a personal account, deleting the user account from the user account set; and
determining whether the user account in the user account set belongs to the same user with other user accounts in the set,
if is the user account belongs to the same user with other user accounts in the set, deleting the user account,
wherein the first user, first user's friends, and a second user are the users corresponding to the user accounts in the user account set.

24. The non-transitory computer-readable storage medium of claim 23, wherein before the step of generating the relevancy attribute information between friends of the first user according to social information of the first user's friends, the method further comprises:
acquiring the friendships between the users corresponding to the user account set, and complementing a unidirectional friendship in the friendships to a bidirectional friendship, wherein
the first user's friends are the acquired friends of the first user according to the complemented friendship.
